(19) United States
(12) Patent Application Publication
(10) Pub. No.: US 2022/0084396 A1
(43) Pub. Date: Mar. 17, 2022

(54) METHOD FOR EXTRACTING ROAD CAPACITY BASED ON TRAFFIC BIG DATA

(71) Applicant: SHANGHAI SEARI INTELLIGENT SYSTEM CO., LTD., Shanghai (CN)

(72) Inventors: Xiao GAO, Shanghai (CN); Yonglai XIAO, Shanghai (CN); Chaoteng WU, Shanghai (CN); Huan WANG, Shanghai (CN); Liangxiao YUAN, Shanghai (CN)

(73) Assignee: SHANGHAI SEARI INTELLIGENT SYSTEM CO., LTD., Shanghai (CN)

(21) Appl. No.: 17/424,887

(22) PCT Filed: Apr. 13, 2020
(86) PCT No.: PCT/CN2020/084557

§ 371 Date: Jul. 22, 2021

(30) Foreign Application Priority Data
Jun. 18, 2019 (CN) 201910525208.8

(51) Int. Cl. G08G 1/01

(52) U.S. Cl. CPC G08G 1/0125

(57) ABSTRACT

A method for extracting road capacity based on traffic big data includes the following steps: selecting a specific traffic flow model; reading massive road lane traffic flow parameters; calibrating a model parameter of the selected traffic flow model by using the road lane traffic flow parameters read in the previous step; and fitting the calibrated model parameter to obtain a fitted traffic flow model. The present invention solves the problems that traditional methods for traffic capacity calibration have a heavy workload, inadequate samples and unreliable results due to their reliance on manual information acquisition, thereby providing support for automatic, long-term, large-scale and precise acquisition of the capacity.

### CROSS REFERENCE TO THE RELATED APPLICATIONS

This application is the national phase entry of International Application No. PCT/CN2020/084557, filed on Apr. 13, 2020, which is based upon and claims priority to Chinese Patent Application No. 201910525208.8, filed on Jun. 18, 2019, the entire contents of which are incorporated herein by reference.

### TECHNICAL FIELD

The present invention belongs to the technical field of intelligent traffic applications, and more particularly, relates to a method for extracting road capacity based on a road network model.

### BACKGROUND

Traditional methods for road capacity calibration need to obtain original traffic flow parameters by the way of manual field surveys, which entail a heavy workload. Moreover, the data obtained in this way are not precise enough and have a limited range in time and space, resulting in inadequate capacity samples and low reliability. With the development of information technologies, large-scale and real-time collection of traffic information has been achieved, leading to an accumulation of massive original traffic flow parameters. Hence, automatic calibration and acquisition of road capacity from these original traffic flow parameters have important implications for obtaining the capacity of a road network and calibrating the corresponding influencing factors.

### SUMMARY

An objective of the present invention is to provide a capacity extraction method suitable for road planning, road design, traffic control, and traffic evaluation and decision-making.

To achieve the above-mentioned objective, the technical solutions of the present invention provide a method for extracting road capacity based on traffic big data, including the following steps:

step 1: selecting a specific traffic flow model;

step 2: reading massive road lane traffic flow parameters;

step 3: calibrating a model parameter of the traffic flow model selected in step 1 by using the road lane traffic flow parameters read in step 2, wherein step 3 includes the following sub-steps:

step 301: determining N initial groups of the road lane traffic flow parameters;

step 302: determining a fitness function λ(i,d) according to the following formula, wherein i represents a lane number, and d represents a date:

$$λ ( i , d ) = \sqrt{{\sum }_{t = 1}^{n} \frac{{( {V}^{⋒} ( i , t ) - V ( i , t ) )}^{2}}{n - 1} t ⋐ d} ;$$

wherein t represents a timestamp, n represents a time series number of a sample in a day; V(i,t) represents an actual vehicle speed collected on an i^{th} lane at a time point t; and \hat{V}(i,t) represents a vehicle speed of the i^{th} lane at the time point t, fitted by using the traffic flow model;

step 303: determining a group update rule as follows: retaining N1 group samples with a highest fitness value, discarding N2 group samples with a lowest fitness value, randomly generating N3 new group samples, and obtaining an average value of fitness values of each two samples of the (N-N1-N2-N3) samples with medium fitness values to generate (N-N1-N2-N3) samples;

step 304: iterating the traffic flow model selected in step 1 according to the group update rule determined in step 303; and

step 305: determining an iteration termination condition, and updating an output result to a database; and

step 4: fitting the calibrated model parameter to obtain a fitted traffic flow model.

Preferably, the traffic flow parameters include a lane number, a timestamp, a vehicle flow, a vehicle speed, and a vehicle density.

Preferably, in step 305, the iteration termination condition is: for two consecutive iterations, a difference between model parameters with the lowest fitness value is less than a specified value, a difference between free-flow vehicle speeds is less than 1, a difference between critical vehicle densities is less than 1, and a difference between exponential parameters is less than 0.05.

Preferably, after step 4, the method further includes:

step 5: obtaining capacities of lanes through derivation based on the traffic flow model obtained in step 4;

step 6: combining the capacities of the lanes obtained in step 5 according to a composition relationship between the lanes and a road transect to obtain a capacity of the corresponding road transect; and

step 7: determining influencing factors of the capacity of the road transect, and quantitatively calibrating each influencing factor based on the capacity of each road transect obtained in step 6.

The present invention solves the problems that traditional methods for traffic capacity calibration have a heavy workload, inadequate samples and unreliable results due to their reliance on manual information acquisition, thereby providing support for automatic, long-term, large-scale and precise acquisition of the capacity.

### BRIEF DESCRIPTION OF THE DRAWINGS

FIG. 1 shows the overall process of capacity extraction;

FIG. 2 shows the process of calibrating a lane traffic flow model;

FIG. 3 shows an example of calibrating the lane traffic flow model;

FIG. 4 shows a distribution of lane capacities;

FIG. 5 shows the influence of the quantity of lanes on the capacity;

FIG. 6 shows the influence of rainy weather on the capacity;

FIG. 7 shows the influence of snowy weather on the capacity;

FIG. 8 shows the influence of an accident on the capacity;

FIG. 9 shows the lane traffic flow parameters; and

FIG. 10 shows the initial groups of lane traffic flow parameters.

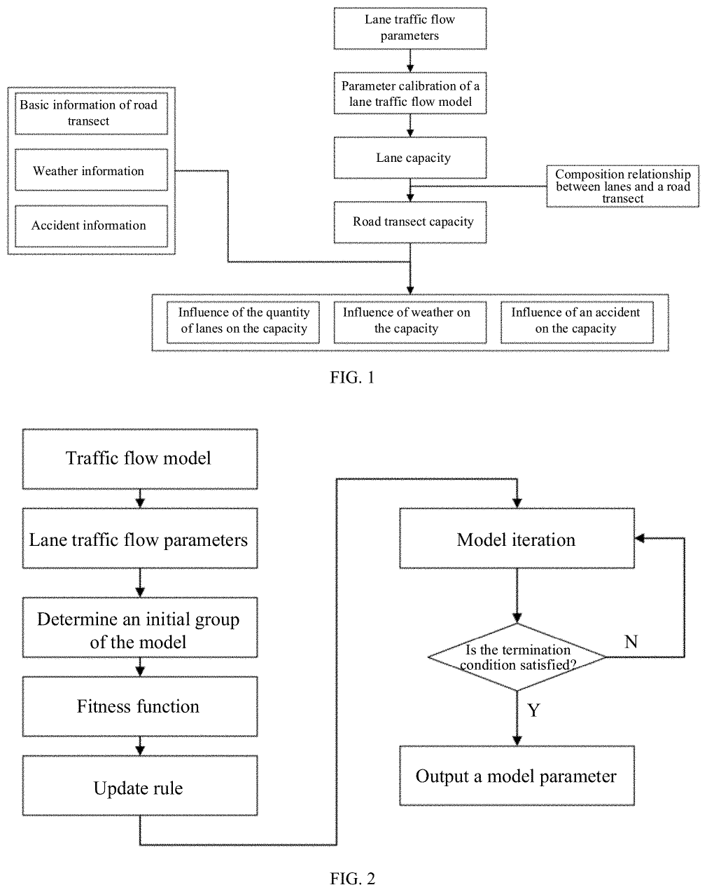

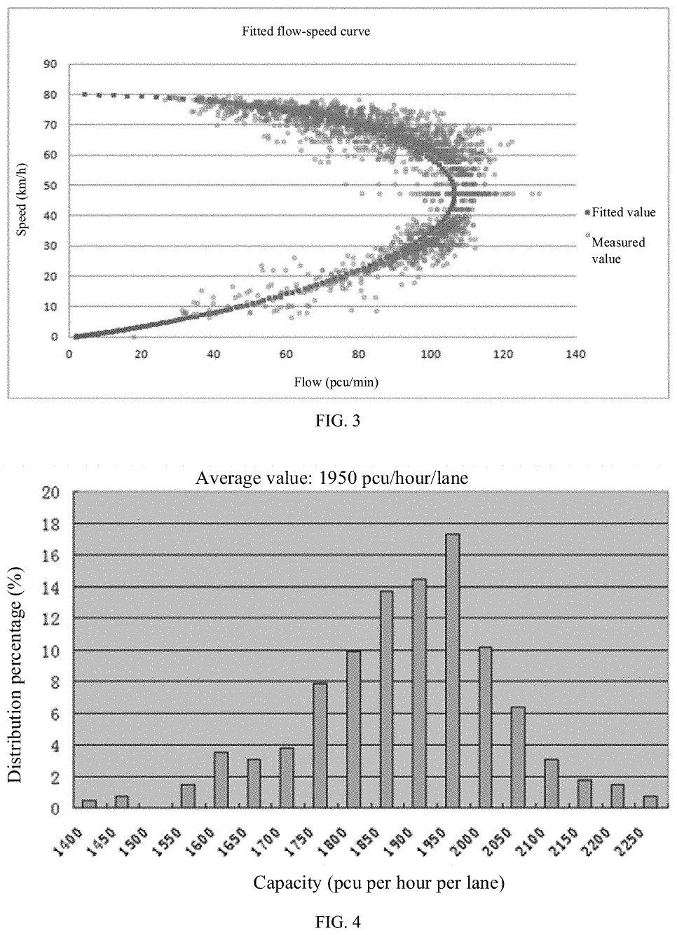

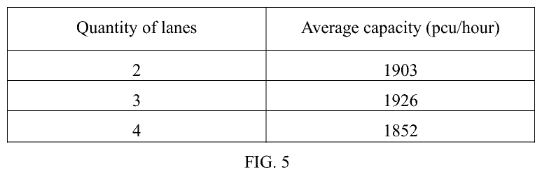

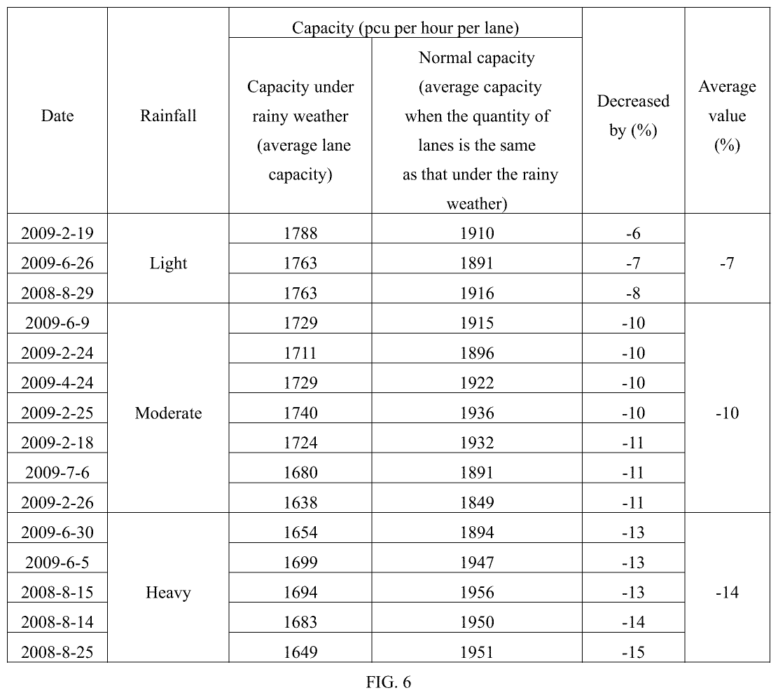

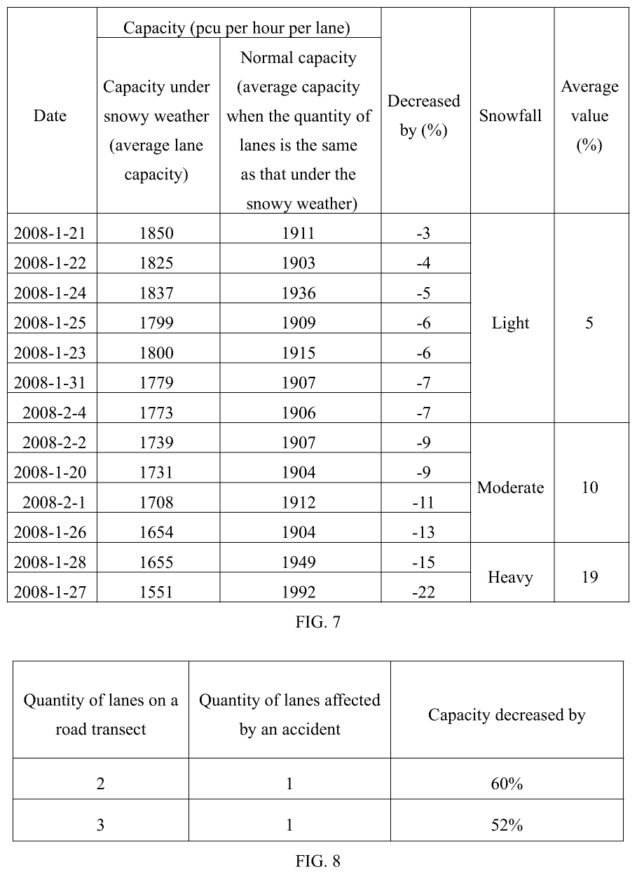

### DETAILED DESCRIPTION OF THE EMBODIMENTS

The present invention will be described in detail below with reference to the specific embodiments. It should be understood that these embodiments are only intended to illustrate the present invention rather than to limit the scope of the present invention. In addition, it should be understood that those skilled in the art can make various changes and modifications to the present invention after reading the content of the present invention, and these equivalent forms shall also fall within the scope defined by the appended claims of the present invention.

Step 1: a traffic flow model is selected. In this embodiment, the selected traffic flow model is a flow-density relationship, which is an exponential model expressed as follows:

$$V ( K ) = {V}_{f}^{*} exp \{ - \frac{1}{{a}_{m}} {( \frac{K}{{K}_{cr}} )}^{{a}_{m}} \} ;$$

$$Q ( K ) = V ( K ) * K ;$$

wherein, K represents a density, in units of pcu/kilometer; V(K) represents a speed, in units of kilometers/hour; Q(K) represents a flow, in units of pcu/hour; K_{cr} represents a critical density, in units of pcu/kilometer; V_{f} represents a free-flow vehicle speed, in units of kilometers/hour; and aₘ represents a dimensionless exponential parameter.

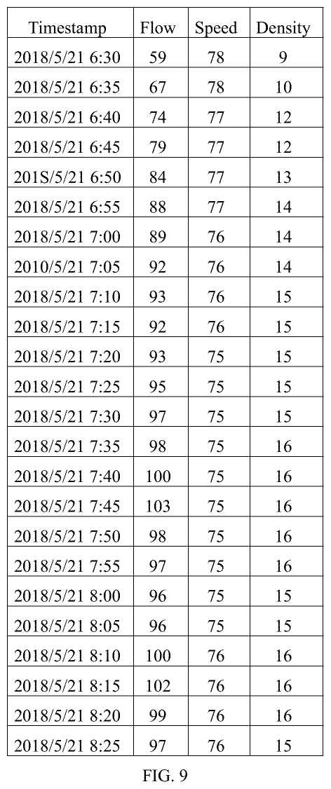

Step 2: lane traffic flow parameters are read, wherein the traffic flow parameters include a lane number, a timestamp (at an interval of five minutes), a flow, a speed, and a density, as shown in FIG. 9.

Step 3: a parameter of the lane traffic flow model is calibrated by the following steps and fitted by using a genetic algorithm.

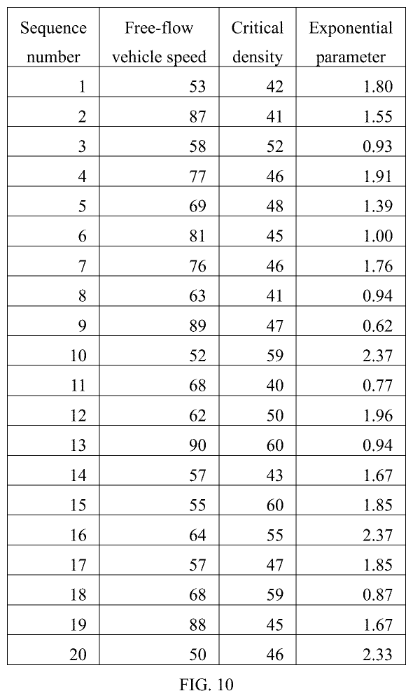

Step 301: 20 initial groups of the lane traffic flow parameters are determined, as shown in FIG. 10.

Step 302: a fitness function λ(i,d) is determined according to the following formula, wherein i represents the lane number, and d represents a date:

$$λ ( i , d ) = \sqrt{{\sum }_{t = 1}^{n} \frac{{( {V}^{⋒} ( i , t ) - V ( i , t ) )}^{2}}{n - 1} t ⋐ d} ;$$

wherein t represents the timestamp, n represents a time series number of a sample in a day; V(i,t) represents an actual vehicle speed collected on the i^{th} lane at a time point t; and \hat{V}(i,t) represents a vehicle speed of the i^{th} lane at the time point t, fitted by using the traffic flow model.

Step 303: a group update rule is determined as follows: retaining 5 group samples with a highest fitness value, discarding 5 group samples with a lowest fitness value, randomly generating 5 new group samples, and obtaining an average value of fitness values of each two samples of the 10 samples with medium fitness values to generate 10 samples.

Step 304: the traffic flow model selected in step 1 is iterated according to the group update rule determined in step 303.

Step 305: an iteration termination condition is determined, and an output result is updated to a database, wherein the iteration termination condition is: for two consecutive iterations, a difference between model parameters with the lowest fitness value is less than a specified value, a difference between free-flow vehicle speeds is less than 1, a difference between critical vehicle densities is less than 1, and a difference between exponential parameters is less than 0.05.

Step 4: capacities of lanes are obtained through derivation based on the lane traffic flow model by using the free-flow vehicle speed and the critical density, and an output result is updated to the database.

Step 5: basic information of a matching road transect is read, namely the lanes that constitute the road transect are obtained, the capacities of the corresponding lanes obtained in step 4 are combined to obtain the capacity of the corresponding road transect, the influence of road conditions such as the width, bend, and slope of the road transect on the capacity are calibrated, and an output result is updated to the database.

Step 6: the matching weather information is read, the influence of rainy and snowy weather on the capacity is quantitatively calibrated, and an output result is updated to the database. For example, the capacities under the rainy and snowy weather are calibrated based on the weather information.

Step 7: the matching accident information is read, the influence of an accident on the capacity is quantitatively calibrated, and an output result is updated to the database. For example, the capacity under the rainy weather is calibrated based on the accident information.

What is claimed is:

1. A method for extracting a road capacity based on traffic big data, comprising the following steps:
step 1: selecting a predetermined traffic flow model;
step 2: reading a plurality of road lane traffic flow parameters;
step 3: calibrating a model parameter of the predetermined traffic flow model selected in step 1 by using the plurality of road lane traffic flow parameters read in step 2 to obtain a calibrated model parameter, wherein step 3 comprises the following sub-steps:
step 301: determining N initial groups of the plurality of road lane traffic flow parameters;
step 302: determining a fitness function λ(i,d) according to the following formula, wherein i represents a lane number, and d represents a date:
$$λ ( i , d ) = \sqrt{{\sum }_{t = 1}^{n} \frac{{( {V}^{⋒} ( i , t ) - V ( i , t ) )}^{2}}{n - 1} t ⋐ d} ;$$
wherein t represents a timestamp, n represents a time series number of a sample in a day; V(i,t) represents an actual vehicle speed collected on an i^{th} lane at a time point t; and \hat{V}(i,t) represents a vehicle speed of the i^{th} lane at the time point t, wherein the vehicle speed of the i^{th} lane at the time point t is fitted by using the predetermined traffic flow model;
step 303: determining a group update rule as follows: retaining N1 first group samples with a highest fitness value, discarding N2 second group samples with a lowest fitness value, randomly generating N3 third group samples, and obtaining an average value of fitness values of each two fourth samples of (N-N1-N2-N3) fourth samples with medium fitness values to generate (N-N1-N2-N3) fifth samples;
step 304: iterating the predetermined traffic flow model selected in step 1 according to the group update rule determined in step 303; and
step 305: determining an iteration termination condition, and updating an output result to a database; and
step 4: fitting the calibrated model parameter to obtain a fitted traffic flow model.

2. The method according to claim 1, wherein
the plurality of road lane traffic flow parameters comprise a lane number, a timestamp, a vehicle flow, a vehicle speed, and a vehicle density.

3. The method according to claim 2, wherein
in step 305, the iteration termination condition is: for two consecutive iterations, a difference between model parameters with the lowest fitness value is less than a specified value, a difference between free-flow vehicle speeds is less than 1, a difference between critical vehicle densities is less than 1, and a difference between exponential parameters is less than 0.05.

4. The method according to claim 1, wherein
after step 4, the method further comprises:
step 5: obtaining capacities of lanes through a derivation based on the fitted traffic flow model obtained in step 4;
step 6: combining the capacities of the lanes obtained in step 5 according to a composition relationship between the lanes and a road transect to obtain a capacity of the road transect corresponding to the lanes; and
step 7: determining influencing factors of the capacity of the road transect, and quantitatively calibrating each of the influencing factors based on the capacity of the road transect obtained in step 6.
